(19) United States
(12) Patent Application Publication
(10) Pub. No.: US 2003/0043972 A1
(43) Pub. Date: Mar. 6, 2003

(54) Wireless entertainment system for a vehicle

(76) Inventors: Robert J. Burnham, Novi, MI (US); Mike Mayer, Dexter, MI (US)

Correspondence Address: Steven L. Oberholtzer, BRINKS HOFER GILSON & LIONE, P.O. Box 10395, Chicago, IL, 60610, US

(21) Appl. No.: 09/941,313

(22) Filed: Aug. 29, 2001

(51) Int. Cl. H04B 10/00

(52) U.S. Cl. 379/56.3; 455/575

(57) ABSTRACT

An entertainment system for a passenger compartment of a vehicle, including a lamp assembly mountable within the passenger compartment of the vehicle and having a light source adapted to illuminate the passenger compartment and a transmitter connectable to an audio source and adapted to receive information from the audio source and to transmit signals containing the information within the passenger compartment of the vehicle, and at least one pair of wireless headphones equipped with a sensor, which is capable of receiving said signals, and adapted to convert to the signals into sound.

### TECHNICAL FIELD

This invention relates generally to entertainment systems for use in a vehicle, and more particularly to an entertainment system involving the use of wireless headphones.

### BACKGROUND OF THE INVENTION

Since the advent of the car radio, it has been common practice to listen to the radio while driving cars. In the early years, car audio systems were AM radios that offered very few listening choices. However, in recent years, car audio technology has made dramatic advances and the listening choices now seem endless. Most modern day vehicles allow the occupants a choice of listening to an AM radio, a FM radio, a cassette player, a MP3 player, or a CD player. In fact, it is becoming increasingly common to find televisions, VCRs, DVD players, and video game systems installed in vehicles. While these technological advances have been aimed at maximizing the traveling pleasure of children (typically in the backseat), the traveling pleasure of parents has been neglected. The sounds of a radio talk show intended to entertain an entire family have been replaced with the clamor of pop music, cartoons, and video games. There is a need for an entertainment system for use in a vehicle, which is able to entertain those passengers interested in being entertained without annoying others.

### BRIEF DESCRIPTION OF THE DRAWINGS

FIG. 1 is a schematic side view of the entertainment system of the preferred embodiment of the invention located in the interior of a vehicle.

FIG. 2 is a prospective view of a lamp assembly of the preferred embodiment of the invention.

### DETAILED DESCRIPTION OF THE INVENTION

The following description of the preferred embodiment of the invention and the two preferred methods of supplying the invention are not intended to limit the scope of this invention, but rather to enable any person skilled in the art of entertainment systems to make and use this invention.

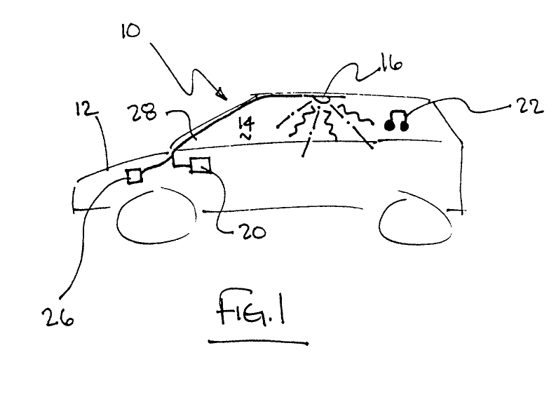

As shown in FIG. 1, the invention is an entertainment system 10, which is comprised of a lamp assembly 16, an audio source 20, and wireless headphones 22. The entertainment system enables persons within the passenger compartment 14 of the vehicle 12 to listen to the audio source 20 via the wireless headphones 22 without bothering or annoying the driver of the vehicle 12. In addition, the lamp assembly 16 of the entertainment system 10 is capable of illuminating the passenger compartment 14 of the vehicle 12.

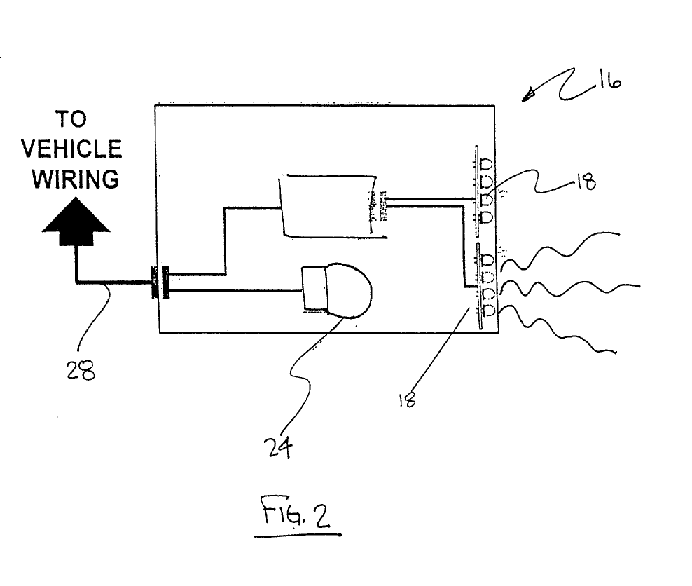

As shown in FIG. 2, the lamp assembly 16 includes a light source 24 and at least one transmitter 18. The function of the light source 24 is to illuminate the passenger compartment of the vehicle. The light source 24 is preferably activated and deactivated by pressing a button (not shown) on the lamp assembly 16. Alternatively, the light source 24 may be activated and deactivated by any other suitable means, such as motion detection, sound detection, or remote control. The light source 24 is preferably a conventional incandescent bulb. However, any other suitable device for producing light, such as an LED device, may be used as the light source 24. The light source 24 is preferably connected to a power source 26, as shown in FIG. 1, which delivers the power required for the light source 24 to emit light within the passenger compartment 14 of the vehicle 12. Preferably, the power source 26 is the battery or alternator of the vehicle 12. Alternatively, an independent battery pack, a solar panel, or any other suitable power-generating device may be used as the power source 26 of the entertainment system 10. In the preferred embodiment, the light source 24 is connected to the power source 26 by wiring 28. The connection between these two devices, however, depends on the types of devices used for the light source 24 and the power source 26. Thus, any suitable device capable of transferring power may be used to provide the connection between the light source 24 and the power source 26.

As shown in FIG. 2, the second major element found within the lamp assembly 16 is the transmitter 18. The function of the transmitter 18 is to convert information being received from the audio source into signals and to transmit those signals within the passenger compartment of the vehicle. Once transmitted within the passenger compartment of the vehicle, the signals may be received by the wireless headphones and converted into sound for the listening pleasure of an occupant of the vehicle. The transmitter 18 is preferably an infrared transmitter adapted to transmit infrared signals. The infrared transmitter functions by receiving information from the audio source via wiring 28 and converting that information into infrared signals that the transmitter then transmits within the passenger compartment of the vehicle. Because the use of infrared devices requires line-of-sight connections, an interior lamp, which is usually mounted on the ceiling or headliner of the passenger compartment of a vehicle, is a preferred place to locate the lamp assembly 16. Alternatively, the transmitter 18 may be adapted to transmit supersonic signals or any other suitable type of signal. The transmitter 18 is preferably adapted to transmit digital signals, but the transmitter 18 may alternatively be adapted to transmit analog signals, analog/digital signals, or any other suitable type of signal. Preferably, the transmitter 18 is a conventional LED device. However, any other suitable device for transmitting signals may be used as the transmitter 18.

As shown in FIG. 1, the audio source 20 functions to provide the transmitter with information that may eventually be converted into sound by the wireless headphones 22. The audio source 20 is preferably a conventional radio, cassette player, or CD player. However, the audio source 20 may alternatively be a conventional television, VCR, DVD player, MP3 player, or any other suitable device for transferring information capable of being converted into sound. The audio source 20 may be a preexisting device in the vehicle, which primarily functions to provide multiple speakers (not shown) with sound signals. In this manner, a preexisting device may be integrated into the entertainment system; therefore, the audio source 20 does not have to, although it may, be specially designed for the entertainment system 10. As discussed above, the audio source 20 is preferably connected to the transmitter 18 by wiring 28. Alternatively, any other suitable method of enabling the transfer of information from the audio source 20 to the transmitter 18, such as fiber optics, may be used, such as an optical fiber or a radio frequency (RF) transmitter/receiver.

Wiring 28 is preferably used both to connect the power source 26 to the light source and to connect the audio source 20 to the transmitter. In the first configuration discussed above, the purpose of the wiring 28 is to transfer the power generated by the power source 26 to the light source, so that light may be emitted within the passenger compartment 14 of the vehicle 12. In the second configuration discussed above, the function of the wiring 28 is to transfer the information generated by the audio source 20 to the transmitter, so that the information may be transmitted within the passenger compartment 14 of the vehicle 12 in the form of signals. The wiring 28 is preferably made of conventional materials and using conventional methods.

As discussed above, the function of the wireless headphones 22 is to receive the signals being transmitted by the transmitter and to convert those signals into sound. The wireless headphones 22 are preferably conventional wireless headphones. Similar to the audio source 20, the wireless headphones 22 may, but need not, be designed specifically for the entertainment system 10. The wireless headphones 22 are connected to the transmitter by way of a sensor located within the wireless headphones 22. While the wireless headphones 22 are not physically connected to the transmitter, the sensor that is located within the wireless headphones 22 is able to receive signals being transmitted within the passenger compartment 14 of the vehicle 12 by the transmitter, thereby connecting the wireless headphones 22 and the transmitter. As discussed above, the connection between the wireless headphones 22 and the transmitter is preferably achieved using infrared signals that are transmitted by the transmitter and received by the wireless headphones 22. However, any suitable method for achieving this connection between the two devices may be used.

The first preferred method of supplying the entertainment system to consumers entails supplying a vehicle manufacturer with the lamp assembly, which is to be installed with the wiring connected to the audio source of the vehicle as they are manufactured and supplying consumers with the wireless headphones. The lamp assembly comprising the transmitter and the light source will be an element that is supplied and installed by the manufacturer of the vehicle. The wireless headphones, on the other hand, are preferably sold directly to the consumer as a separate item, not as part of the vehicle being purchased. However, the wireless headphones may alternatively be sold with the purchase of the vehicle. In addition to the steps mentioned above, other steps, such as receiving orders from customers, may be included.

The second preferred method of supplying the entertainment system to consumers involves supplying the lamp assembly, removing an existing fixture from the passenger compartment of the vehicle, and mounting the lamp assembly in place of the removed fixture. The lamp assembly will preferably be supplied to auto parts venders. Alternatively, the lamp assembly may be supplied to the consumers themselves, entertainment system venders, or any other suitable vender. Removing the existing fixture and mounting the lamp assembly will preferably be done by the consumer. Alternatively, an auto parts vender, an entertainment systems vender, or any other suitable individual may perform the tasks of removing the existing fixture and mounting the lamp assembly.

In addition to supplying a lamp assembly, removing an existing fixture, and mounting a lamp assembly in place of the removed fixture, this method may also require wiring to be provided, the wiring to be installed, and the transmitter to be connected to the audio source by the wiring. Preferably, the wiring will be supplied to an automotive parts vender. Consumers will be able to purchase the wiring along with the lamp assembly. Alternatively, the wiring may be supplied to any suitable vender. Installing the wiring and connecting the transmitter to the audio device will preferably be done by the consumer. However, these tasks may be performed by any suitable individual. In addition to the steps mentioned above, other steps, such as receiving orders from customers, may be included.

As any person skilled in the art of entertainment systems will recognize from the previous detailed description and from the figures and claims, modifications and changes can be made to the preferred embodiment of the invention without departing from the scope of this invention defined in the following claims.

We claim:

1. An entertainment system for a passenger compartment of a vehicle, comprising: a lamp assembly mountable within the passenger compartment of the vehicle and having a light source connectable to a power source and adapted to illuminate the passenger compartment, and a transmitter connectable to an audio source and adapted to receive information from said audio source and to transmit signals containing the information within the passenger compartment of the vehicle.

2. An entertainment system for a passenger compartment of a vehicle as claimed in claim 1, wherein said transmitter is an LED transmitter.

3. An entertainment system for a passenger compartment of a vehicle as claimed in claim 1, wherein said transmitter is an infrared transmitter adapted to transmit infrared signals.

4. An entertainment system for a passenger compartment of a vehicle as claimed in claim 1, wherein said signals are digital signals.

5. An entertainment system for a passenger compartment of a vehicle as claimed in claim 1, further comprising wiring connecting said transmitter to said audio source.

6. An entertainment system for a passenger compartment of a vehicle, comprising:
a lamp assembly mountable within the passenger compartment of the vehicle and having a light source connectable to a power source and adapted to illuminate the passenger compartment and a transmitter connectable to an audio source and adapted to receive information from said audio source and to transmit signals containing the information within the passenger compartment of the vehicle; and
at least one pair of wireless headphones equipped with a sensor, which is capable of receiving said signals, and adapted to convert to said signals into sound.

7. An entertainment system for a passenger compartment of a vehicle as claimed in claim 6, wherein said transmitter is an LED transmitter.

8. An entertainment system for a passenger compartment of a vehicle as claimed in claim 6, wherein said transmitter is an infrared transmitter adapted to transmit infrared signals.

9. An entertainment system for a passenger compartment of a vehicle as claimed in claim 6, wherein said signals are digital signals and said audio source or said lamp assembly contains an A/D converter.

10. An entertainment system for a passenger compartment of a vehicle as claimed in claim 6, further comprising wiring connecting said transmitter to said audio source.

11. A method of supplying an entertainment system for a passenger compartment of a vehicle, comprising:
supplying a vehicle manufacturer with a lamp assembly mountable within the passenger compartment of the vehicle and having a light source connectable to a power source and adapted to illuminate the passenger compartment and a transmitter connectable to an audio source and adapted to receive information from said audio source and to transmit signals containing the information within the passenger compartment of the vehicle; and
supplying consumers with wireless headphones equipped with a sensor, which is capable of receiving signals, and adapted to convert said signals into sound.

12. A method of supplying an entertainment system for a passenger compartment of a vehicle as claimed in claim 11, wherein said transmitter is an LED transmitter.

13. An entertainment system for a passenger compartment of a vehicle as claimed in claim 11, wherein said transmitter is an infrared transmitter adapted to transmit infrared signals and said sensor is an infrared sensor adapted to convert infrared signals into sound.

14. A method of supplying an entertainment system for a passenger compartment of a vehicle as claimed in claim 11, wherein said signals are digital signals and said audio source or said lamp assembly contains an A/D converter.

15. A method of supplying an entertainment system for a passenger compartment of a vehicle as claimed in claim 11, further comprising the acts of providing wiring, installing the wiring in the vehicle, and connecting the transmitter and the audio source with the wiring.

16. A method of supplying an entertainment system for a passenger compartment of a vehicle, comprising the following steps:
providing a lamp assembly mountable within the passenger compartment of the vehicle and having a light source connectable to a power source and adapted to illuminate the passenger compartment and a transmitter connectable to an audio source and adapted to receive information from said audio source and to transmit signals containing the information within the passenger compartment of the vehicle;
removing an existing fixture from the passenger compartment of the vehicle; and
mounting said lamp assembly to the passenger compartment of the vehicle.

17. A method of supplying an entertainment system for a passenger compartment of a vehicle as claimed in claim 16, wherein said transmitter is an LED transmitter.

18. A method of supplying an entertainment system for a passenger compartment of a vehicle as claimed in claim 16, wherein said transmitter is an infrared transmitter adapted to transmit infrared signals.

19. A method of supplying consumers with an entertainment system for a passenger compartment of a vehicle as claimed in claim 16, wherein said signals are digital signals and said audio source or said lamp assembly contains an A/D converter.

20. A method of supplying consumers with an entertainment system for a passenger compartment of a vehicle as claimed in claim 16, further comprising the acts of providing wiring, installing the wiring in the vehicle, and connecting the transmitter and the audio source with the wiring.
